(19) United States
(12) Patent Application Publication
(10) Pub. No.: US 2020/0082484 A1
(43) Pub. Date: Mar. 12, 2020

(54) INTEGRATED SCHOLARSHIP MANAGEMENT SYSTEM AND SCHOLARSHIP OPERATION METHOD USING SAME

(71) Applicant: Hee Jae CHO, Seoul (KR)

(72) Inventor: Hee Jae CHO, Seoul (KR)

(21) Appl. No.: 15/746,803

(22) PCT Filed: Jul. 5, 2016
(86) PCT No.: PCT/KR2016/007243

§ 371 Date: Jan. 23, 2018

(30) Foreign Application Priority Data
Jul. 23, 2015 (KR) 10-2015-0104295

(51) Int. Cl. G06Q 50/20; G06Q 40/00; G06F 16/958

(52) U.S. Cl. CPC G06Q 50/2053; G06F 16/958; G06Q 40/123

(57) ABSTRACT

One embodiment of the present invention relates to an integrated scholarship management system and a scholarship operation method using same, the technical problem to be solved being to enable the batch processing online of work involving various and complicated processes such as searching for scholarship information, submitting a scholarship application, reviewing and evaluating, selecting a scholarship student, paying a scholarship, reporting tax, etc.

### TECHNICAL FIELD

An embodiment of the present invention relates to an integrated scholarship management system for building a system for integrated management of scholarship and management and operation of scholarship business using the same and a method for operating the scholarship using the same.

### BACKGROUND ART

In general, a scholarship is a subsidy for educational expenses for helping students receive further education. Such scholarship is awarded in accordance with a variety of standards including the objective and value of receiving the scholarship.

In general, a scholarship recipient selection process occurs offline. That is, though some scholarship operation institutions receive scholarship application documents online, most scholarship operation institutions receive scholarship application documents and supporting documents by registered mail or through walk-in submissions.

For an applicant, applying for a scholarships time-consuming and requires much effort. With no standard scholarship application form available, applicants must prepare a new application document each time they apply for a scholarship, and must repeatedly have supporting documents issued and submitted. Likewise, in order to receive and handle scholarship application documents offline, scholarship operation institutions must spend a large portion of their budget and time. In addition, more personnel are needed to prepare and distribute online application guidelines, and enter applicant information and examination results. Specifically, scholarship operation institutions must hire or allocate additional workers who can enter information manually in order to digitalize information contained in paper documents submitted by applicants and to create a database thereof.

Since there are insufficient standards of distinctive supporting documents submitted when applying for scholarship, in most cases, too many documents are required, and too much personal information is required as a kind of practice regardless of the characteristics of scholarship (good grades, low-income family/vulnerable group, special scholarships, etc.). Likewise, since supporting documents printed on paper have been received only by mail up until now, only analog data, which cannot be read by machine, are collected. Also, since additional personnel and time are needed to transfer the details of the paper documents and the evaluation results into a digital database, scholarship operation institutions omit or minimize the process of creating a database, leading to an impossible building of a scholarship-related database.

In addition, in most of the previous cases, personal statements, study plans, portfolios, recommendation letters, etc. which have been submitted as printed materials, have been difficult to detect plagiarism and have been difficult to determine whether supporting documents such as diplomas, language test score certificates, qualification certificates, etc. have been forged or not. Since most application papers are submitted as analog data on paper, it is difficult to apply technology for determining if documents are forged or contain any plagiarism.

Likewise, the conventional scholarship management systems have structural issues such as having a high dependency on offline processes, use of analog data, and inefficiency due to absence of standard application forms.

### DETAILED DESCRIPTION OF THE INVENTION

### Technical Problem

An embodiment of the present invention provides an integrated scholarship management system, which is able to collectively handle scholarship business with a variety of complex processes online including searching scholarship information, applying for scholarship, performing evaluation, selecting scholarship recipients, paying the scholarship money, and filing a tax report, and a method for operating the scholarship using the same.

In addition, an embodiment of the present invention provides the integrated scholarship management system, which selects and suggests a variety of scholarship information and a scholarship most appropriate for an applicant online by using an Internet communication network, and helps applicants search and select a scholarship which fits their conditions through the least number of clicks and through a rapid search, and a method for operating the scholarship using the same.

In addition, an embodiment of the present invention provides the integrated scholarship management system, which helps applicants proceed, confirm, and complete all processes of applying for a scholarship they have chosen online, and a method for operating the scholarship using the same.

In addition, an embodiment of the present invention provides the integrated scholarship management system, which, once scholarship recipients are selected, helps scholarship recipients handle businesses such as notification of deposit of scholarship money and transfer of income report documents online as a communication channel with the scholarship operation institution, and a method for operating the scholarship using the same.

In addition, an embodiment of the present invention provides the integrated scholarship management system, which helps examiners, who participate in the scholarship recipient selection process, handle businesses such as notification of deposit of scholarship applicant evaluation participation expenses and transfer of income report documents online as a communication channel with the scholarship operation institution, and a method for operating the scholarship using the same.

In addition, an embodiment of the present invention provides the integrated scholarship management system, which helps a donor, who has given a donation to the scholarship operation institution, handle businesses such as notification of issuance of donation receipt and transfer of donation report documents online as a communication channel with the scholarship operation institution, and a method for operating the scholarship using the same.

### Solution to Problem

According to an embodiment of the present invention, the integrated scholarship management system may comprise: an applicant terminal, in which an application for applying for scholarship is installed, for searching scholarship information by accessing a website through an execution of the application for applying for scholarship, preparing a scholarship application document including information on an applicant, and providing qualification certification information certified by an external certification agency server; a scholarship management server for providing at least one piece of scholarship information through the website, receiving the scholarship application document from the applicant terminal, issuing a registration number, and presenting a final selection result of the scholarship recipients for the scholarship to the applicant terminal; and a scholarship operating institution server for receiving the applicant information from the scholarship management server, selecting scholarship recipients on the basis of the received applicant information, transmitting the applicant information of an applicant selected as a scholarship recipient to the scholarship management server, paying the scholarship money to a bank account of the applicant selected as a scholarship recipient or a bank account of the school, filing a tax report for the scholarship payment, and notifying a year-end tax settlement result of the scholarship payment to the scholarship management server.

The scholarship application document may further comprise bank account information or recommender information, and the scholarship management server may provide a scholarship application form fill-out program preset on the website.

The integrated scholarship management system may further comprise a recommender terminal for receiving a request for issuing a recommendation letter for the applicant who provides recommender information at the request of the scholarship management server, and the recommender terminal may upload the requested recommendation letter for scholarship onto the scholarship management server.

The integrated scholarship management system may further comprise an examiner terminal for receiving the applicant information from the scholarship management server and evaluating the applicant, and the examiner terminal may transmit the applicant evaluation information including the evaluation score to the scholarship management server.

The scholarship management server may receive examiner information from the scholarship operating institution server, and the scholarship operating institution server may receive the applicant evaluation information from the scholarship management server.

The integrated scholarship management system may further comprise: a financial institution server for receiving a payment request for a scholarship application fee from the applicant terminal, executing the payment, and paying the scholarship money to the finally selected scholarship recipient; an educational institution server for receiving information on a notice for recruiting the scholarship recipients from the scholarship operating institution server, transmitting the information to a person in charge of scholarship business in an educational institution or posting the information on a website for scholarship information, and receiving the payment result of the scholarship for the finally selected scholarship recipient; and a government agency server for receiving the tax report filed for the payment of the scholarship from the scholarship operating institution server, and transmitting the year-end tax settlement result for the scholarship payment to the scholarship operating institution server.

The integrated scholarship management system may further comprise a database server for saving information for paying and managing the scholarship, and the database server may comprise: a scholarship database (DB) for saving scholarship information which is classified by at least one item among scholarship type, scholarship money, major, region, and religion; a member database (DB) for saving applicant information and member information including login information; a file database (DB) for saving the supporting document files or supporting documents submitted from the applicant terminal; and a management database (DB) for saving information for selecting scholarship recipients in the scholarship operating institution server, paying the scholarship money to the selected scholarship recipients, and filing a tax report and executing a year-end tax settlement for the scholarship payment.

The scholarship management server may comprise: an applicant module connected to the applicant terminal for providing scholarship information, receiving the scholarship application document, issuing the registration number, and presenting a final selection result; a service module for providing a website containing scholarship information, processing and managing the scholarship application documents after receiving the same, and messaging each step of the procedure information; an external cooperation module connected to the financial institution server, the recommender terminal, and the examiner terminal for transmitting and receiving the information on the procedures for supporting and managing the scholarship; and a control module for controlling the operation of each component which the scholarship management server consists of.

The applicant module may comprise: a scholarship information providing unit for providing the scholarship information to the applicant terminal; an information receiving unit for receiving the scholarship application document, member information, and supporting document files, or supporting documents from the applicant terminal; and an applicants-only supporting unit connected on each channel to the applicant terminal, from which the scholarship application document is submitted, for presenting the processing result and the final selection result. The information receiving unit may receive the bank account information designated for the deposit of the scholarship money from the finally selected scholarship recipient. The applicants-only supporting unit may transmit the year-end tax settlement result notified from the scholarship operating institution server to the applicant terminal of the finally selected scholarship recipient.

The service module may comprise: a web service unit for providing the website containing scholarship information; an application document managing unit for classifying the received scholarship application documents by at least one item among scholarship type, scholarship money, major, region, and religion; a plagiarism verifying unit for comparing the classified scholarship application documents with other pre-saved scholarship application documents and verifying if there is any plagiarism; a forged document determining unit for comparing the classified scholarship application documents with a pre-saved authentic document form and determining if the documents are forged; an application papers auto-generating unit for extracting the scholarship application document which corresponds to the preset information on scholarship eligibility requirements among the classified scholarship application documents, and automatically generating application papers required for applying for the scholarship by using the extracted scholarship application document; a certification information receiving unit for receiving qualification certification information for applying for the scholarship from the external certification agency server; a recommendation letter receiving unit for receiving the recommendation letter for scholarship from the recommender terminal; an applicant evaluation information receiving unit for providing the applicant information to the examiner terminal on the basis of the examiner information received from the scholarship operating institution server, requesting for evaluation of the applicant, and receiving the applicant evaluation information including the examination score from the examiner terminal; a conflicting-interests examining unit for examining if there are conflicting interests between applicants and recommenders or between applicants and scholarship operation institutions on the basis of the applicant information and the recommender information, which are received from the scholarship management server, and the examiner information and the operator information of the scholarship operation institution, which are received from the scholarship operating institution server; an information managing unit for classifying the application papers, qualification certification information, recommendation letter for scholarship, and applicant evaluation information for each applicant, and managing them; and an information transmitting unit for transmitting the application papers, qualification certification information, recommendation letter for scholarship, and applicant evaluation information to the scholarship operating institution server.

In addition, according to another embodiment of the present invention, the method for operating the scholarship may comprise: a first step of accessing the website provided by the scholarship management server through an execution of the application for applying for scholarship installed in the applicant terminal, searching the scholarship information, preparing a scholarship application document including applicant information, and providing the qualification certification information certified by the external certification agency server; a second step of receiving the scholarship application document from the applicant terminal and issuing a registration number; a third step of transmitting the applicant information to the scholarship operating institution server and receiving examiner information from the scholarship operating institution server; a fourth step of requesting for applicant evaluation to the examiner terminal on the basis of the examiner information; a fifth step of receiving the applicant evaluation information reflecting the evaluation from the examiner terminal; a sixth step of transmitting the applicant evaluation information and the applicant information, on which the evaluation is performed, to the scholarship operating institution server; a seventh step of selecting a scholarship recipient on the basis of the applicant evaluation information and the applicant information and transmitting the information of the selected scholarship recipient to the scholarship management server, an eighth step of transmitting a final selection result to the applicant terminal of a finally selected scholarship recipient on the basis of the scholarship recipient information; a ninth step of receiving the inputted bank account information from the applicant terminal of the finally selected scholarship recipient and transmitting the bank account information to the scholarship operating institution server; and a tenth step of depositing the scholarship money into the bank account and transmitting the payment result information to the scholarship management server.

The scholarship application document in the first step may comprise recommender request information. The part between the first step and the second step may further comprise: a process of requesting for issuance of a recommendation letter for scholarship for the applicant to the recommender terminal in accordance with the recommender request information; and a process of receiving the requested recommendation letter for scholarship from the recommender terminal.

The second step may determine whether the scholarship application document corresponds to the preset information on scholarship eligibility requirements or not, and if the scholarship application document is determined to correspond to the preset information on scholarship eligibility requirements, a registration number for the scholarship application document can be automatically issued.

The method for operating the scholarship may further comprise: a step of the scholarship operating institution server performing at least one of the procedures of filing the tax report for the scholarship payment to the selected scholarship recipient, filing the tax report for the participation expenses payment to the examiner who has participated in the scholarship recipient selection process, and reporting about the donor who has given a donation to the scholarship operation institution, receiving a year-end tax settlement report document, and transmitting the year-end tax settlement report document to the scholarship management server.

### Advantageous Effects of Invention

According to an embodiment of the present invention, since the integrated scholarship management system and the method for operating the scholarship using the same collectively process a variety of complex processes including searching scholarship information, applying for scholarship, performing evaluation, selecting scholarship recipients, paying the scholarship, filing a tax report, etc. stepwise within a single platform, convenience for the applicants and efficiency in scholarship business of the scholarship operation institutions can improve.

In addition, an embodiment of the present invention can convert the notice for recruiting the scholarship recipients provided by the scholarship operation institution for searching scholarships into digital data, and thus improve the effectiveness of the search.

In addition, since an embodiment of the present invention allows scholarship-related businesses, which are done by mixing analog data and digital data by various participants (applicants, recommenders, examiners, operators of the operation institutions, etc.) online/offline, to be conducted collectively by digital method online, digital data on scholarship can be built in real time, and the data can be used for evaluating performances of the existing scholarship, designing a new scholarship, analyzing scholarship market, etc.

In addition, an embodiment of the present invention can improve efficiency, speed, and accuracy of work by building a paperless scholarship business management system.

In addition, since an embodiment of the present invention can determine and examine if there is any plagiarism, forged documents, or conflicting interests, etc., it is possible to examine and control plagiarism, forged documents, and conflicting interests in advance, and enhance fairness of examination.

In addition, an embodiment of the present invention can build a network between public scholarship institutions, private scholarship institutions, and educational institutions, allowing for exchange of scholarship information with each other, thereby controlling, in advance, issues of double application for scholarship, and contributing in preventing damages due to double application for scholarship.

### BRIEF DESCRIPTION OF DRAWINGS

FIG. 1 is a drawing which briefly shows the integrated scholarship management system according to an embodiment of the present invention.

FIG. 2 is a block diagram which briefly shows the scholarship management server of FIG. 1.

FIG. 3a is a block diagram which briefly shows the applicant module of FIG. 2.

FIG. 3b is a block diagram which briefly shows the service module of FIG. 2.

FIG. 4 is a block diagram which briefly shows the database server of FIG. 1.

FIG. 5 is a drawing which shows a detailed list of the database server of FIG. 4.

FIG. 6 is a flowchart which shows the method for operating the scholarship according to another embodiment of the present invention.

FIG. 7 is a flowchart which shows the flow, with special emphasis on the applicant, in the method for operating the scholarship according to another embodiment of the present invention.

FIG. 8 is a flowchart which shows the flow, with special emphasis on the recommender, in the method for operating the scholarship according to another embodiment of the present invention.

FIG. 9 is a flowchart which shows the flow, with special emphasis on the examiner, in the method for operating the scholarship according to another embodiment of the present invention.

FIG. 10 is a flowchart which shows the process of searching scholarship in the method for operating the scholarship according to another embodiment of the present invention.

FIG. 11 is a drawing of the method for comprehensively managing the overall processes of scholarship business including searching scholarship information, applying for scholarship, performing evaluation, selecting the scholarship recipients, paying the scholarship money, filing a tax report, etc. by using the method for operating the scholarship according to another embodiment of the present invention.

### BEST MODE FOR CARRYING OUT THE INVENTION

A brief description of terminology used in this specification and specific description of the present invention are provided herein.

Although general terms which are currently widely used are selected as the terms used in the present disclosure while taking into account functions of the present invention, the terms may vary according to the intention of one of ordinary skill in the art, judicial precedents, or the appearance of new technology. In addition, in specific cases, terms intentionally selected by the applicant may be used, and in this case, the meaning of the terms will be disclosed in a corresponding description of the invention. Accordingly, the terms used in the present invention should be defined not by simple names of the terms but by the meaning of the terms and the contents over the present invention.

It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof. Those skilled in the art would further appreciate that the various illustrative configurations, modules, and algorithm steps described in connection with the embodiments disclosed herein may be implemented as hardware, software, or combinations of both.

Some embodiments of the present invention are described below, by way of example only, with reference to the accompanying drawings. Although the present invention will be described in the following with reference to particular embodiments thereof, the present invention is not limited thereto and various modifications can be made thereto. In some instances, well-known structures and techniques are illustrated with the omission of unnecessary detail in order to avoid obscuring the embodiments. In the accompanying figures, like reference numbers indicate similar element.

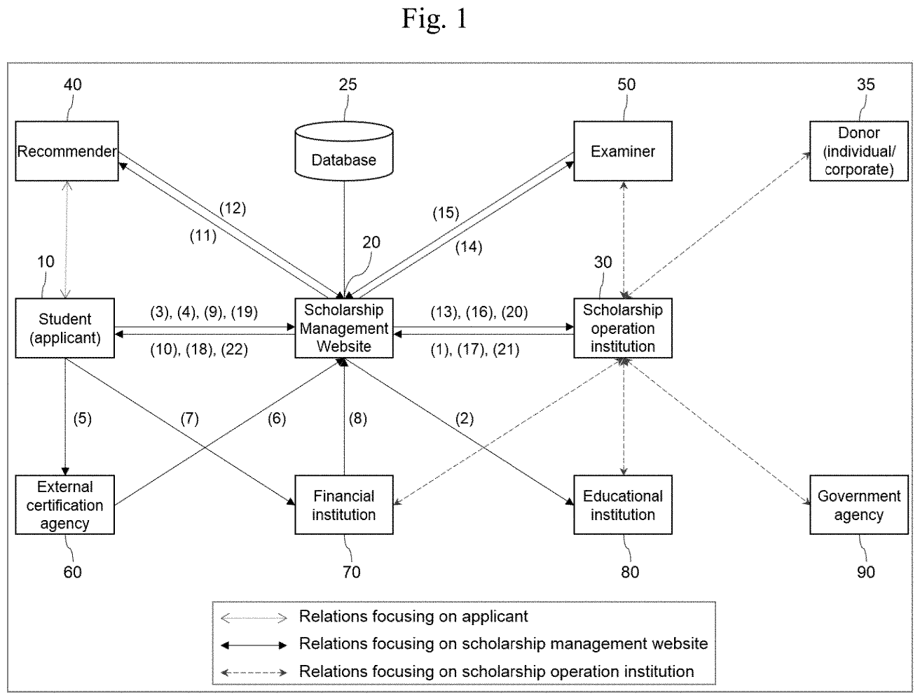

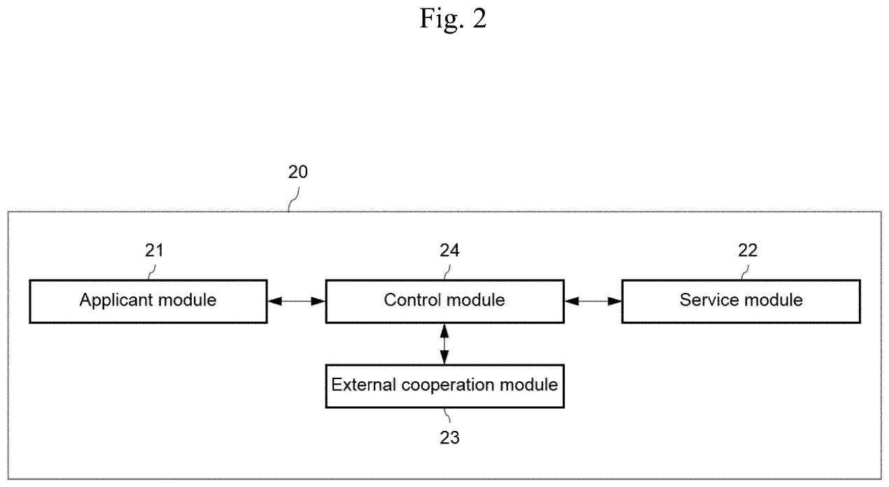

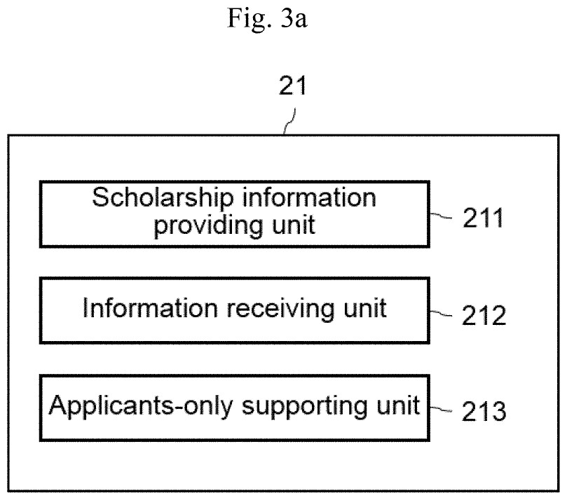

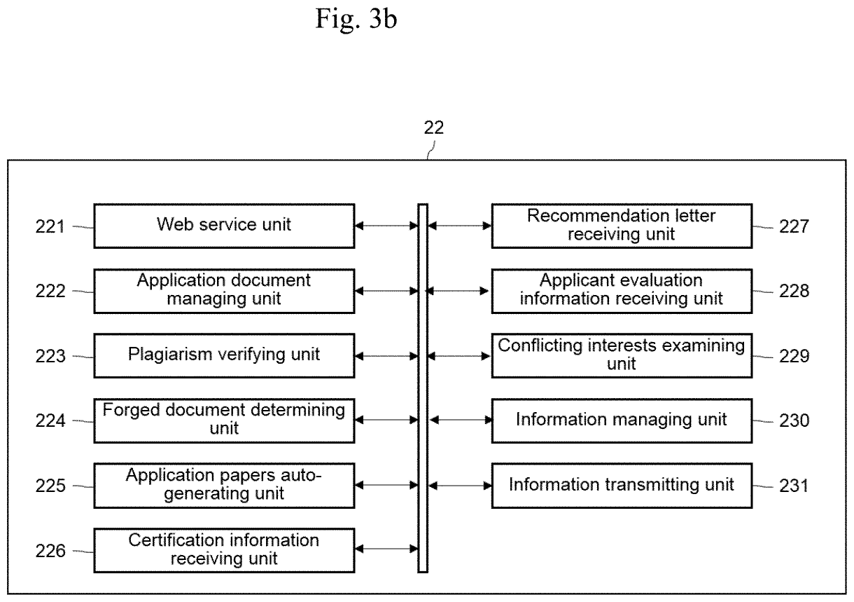

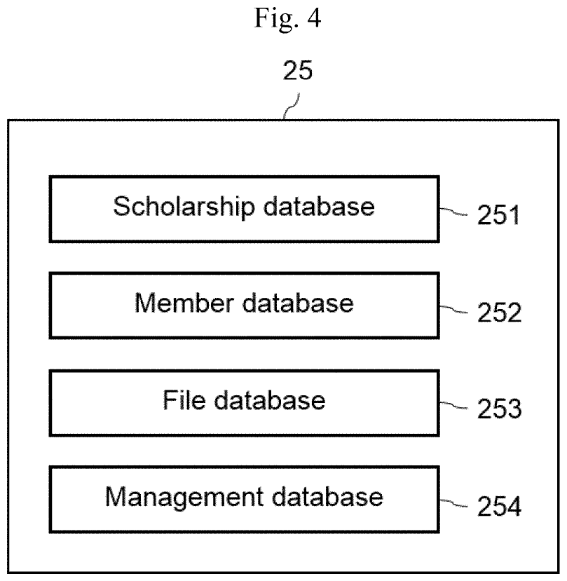

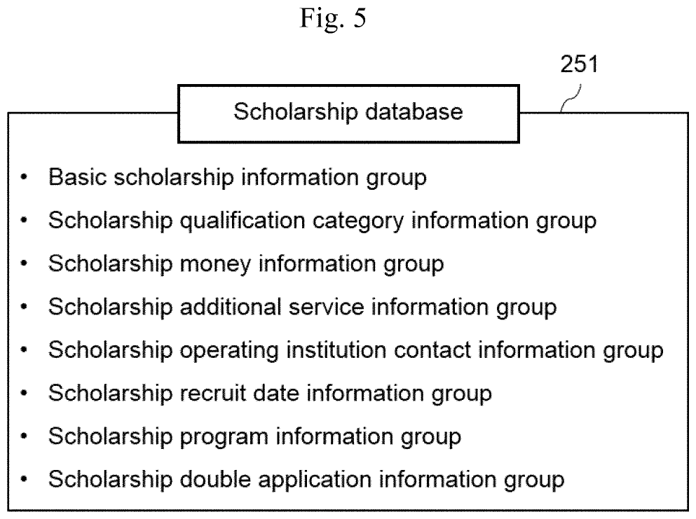

FIG. 1 is a drawing which briefly shows the integrated scholarship management system according to an embodiment of the present invention. FIG. 2 is a block diagram which briefly shows the scholarship management server of FIG. 1. FIG. 3a is a block diagram which briefly shows the applicant module of FIG. 2. FIG. 3b is a block diagram which briefly shows the service module of FIG. 2. FIG. 4 is a block diagram which briefly shows the database server of FIG. 1. FIG. 5 is a drawing which shows a detailed list of the database server of FIG. 4.

Referring to FIG. 1, the integrated scholarship management system according to an embodiment of the present invention is a system for handling all processes such as searching scholarship information, applying for scholarship, performing evaluation, selecting scholarship recipients, paying the scholarship money, filing a tax report, etc. which comprises: the applicant terminal (10); the scholarship management server (20); and the scholarship operating institution server (30).

In addition, the integrated scholarship management system is connected to the recommender terminal (40), examiner terminal (50), donor terminal (35), database server (25), external certification agency serer (60), and financial institution server (70) through the scholarship management server (20), and is connected to the financial institution server (70), educational institution server (80), and government agency server (90) through the scholarship operating institution server (30), in order to comprehensively manage scholarship-related businesses (i.e. giving a notice on selecting scholarship recipients, receiving scholarship application papers, submitting a recommendation letter, entering the evaluation score by an examiner, notifying the evaluation result, notifying that the scholarship money is deposited, and filing a year-end tax settlement report to the National Tax Service).

The integrated scholarship management system provides the results and messages to the applicant, which are generated in all the processes from searching scholarship information to executing a year-end tax settlement of the payment of the scholarship money, and a customized, integrated scholarship management service with special emphasis on the applicants for them to check the progress online by step after they apply for scholarship on the display of the channel of the applicants-only supporting unit (213) of the scholarship management server (20) connected to the applicant terminal.

The applicant terminal (10), which is a terminal device for an applicant who applies for scholarship and in which an application for applying for scholarship is installed, searches scholarship information by accessing a website, which is provided by the scholarship management server (20), through an execution of the application for applying for scholarship, prepares a scholarship application document including information on an applicant, and provides qualification certification information certified by the external certification agency server (60). The application for applying for scholarship can be downloaded from the scholarship management server (20) or through a specific online path such as the App Store. Meanwhile, the applicant terminal (10) is a device which is able to run the application for applying for scholarship or a program, which realizes the above operations, and may include personal information terminals such as an IPad, personal digital assistant (PDA), hand personal computer (HPC), web pad, laptop computer, wireless application protocol (WAP) phone, palm PC, e-book terminal, hand held terminal (HHT), etc., as well as a smartphone.

The scholarship management server (20) receives information on the scholarship recipient selection process from the scholarship operating institution server (30) (refer to (1) of FIG. 1), and transmits the details on the notice for recruiting the scholarship recipients to the educational institution server (80) (refer to (2) of FIG. 1).

The applicant terminal (10) accesses the website provided by the scholarship management server (20) by an applicant's operation, searches scholarship information (refer to (3) of FIG. 1), prepares a scholarship application document by using a scholarship application form fill-out program, which is preset in the website (refer to (4) of FIG. 1), requests for certification of qualifications to the external certification agency server (60) (refer to (5) of FIG. 1), and provides information of the certification result to the scholarship management server (20) (refer to (6) of FIG. 1). Here, the design may allow the information of the certification result to be directly notified from the external certification agency server (60) to the scholarship management server (20).

In addition, the applicant terminal (10) accesses an external financial institution server, and executes payment of scholarship application fee for the scholarship application document (refer to (7) of FIG. 1). Likewise, after the scholarship application fee is paid, the financial institution server (70) notifies the payment result to the scholarship management server (20) (refer to (8) of FIG. 1).

Meanwhile, the scholarship application document may include bank account information or recommender (mentor, teacher, etc.) request information in addition to the applicant information.

Table 1 shows an example of matters described in a scholarship application document.

TABLE 1

| Category | Papers to Be Submitted |
|---|---|
| Basic | 1. Application Document 2. Student Record 3. Academic |
| Information | Transcript 4. Proof of Enrollment 5. Certificate of |
| | Acceptance 6. Recommendation Letter 7. Personal |
| | Statement/Study Plan 8. Double Application Confirmation |
| | 9. Family Relation Certificate 10. Consent on Collecting, |
| | Using, Providing, and Verifying Personal Information 11. |
| | Written Oath |
| Good | 1. Language test/Test scores (Korean language, Korean |
| Grades & | history, TOEFL GRE, etc.) 2. Admission to a university |
| Specialty | abroad, certificates of receiving an award (art, music, and |
| | physical education, language, science, mathematics, etc.) |
| Low-Income | 1. National Basic Livelihood Security Recipient Certificate |
| family & | 2. Near Poverty Group Certificate (Single-Parent Family |
| Vulnerable | Certificate, Disability Allowance Recipient Confirmation, |
| Social | Self-Support Worker Confirmation, Certificate of Near |
| Group | Poverty Group with Primary Care, Charge-Reduced Mobile |
| | Phone Certificate, Notice of Result of Request for Payment |
| | for Welfare Recipients, Near Poverty Self-Payment- |
| | Reduced Person Certificate, etc.) 3. Receipt of Health |
| | Insurance Payment 4. Facility Resident Confirmation 5. |
| | Disabled Person Certificate |
| Miscel- | 1. Tax Payment Certificate (parents/legal guardian) 2. Copy |
| laneous | of bankbook of a financial institution 3. Mentor Approval |
| | and Consent 4. Receipt of Tuition Payment 5. Certificate of |
| | Military Service 6. Immigration Fact Certificate 7. |
| | Volunteer Activity Certificate |

The scholarship management server (20) is a server device for a company or a management body, which provides the integrated scholarship management service. The scholarship management server (20) provides at least one piece of scholarship information through the website, receives the scholarship application document (refer to (9) of FIG. 1) from the applicant terminal (10), and issues the registration number (refer to (10) of FIG. 1).

Specifically, the scholarship management server (20), when a scholarship applicant requests for a recommendation letter, transmits information for requesting for a recommendation letter to the recommender terminal (40) by e-mail, mobile text message, etc. (refer to (11) of FIG. 1). Here, if the recommender accesses the website of the scholarship management server (20), which is linked to the information for requesting for a recommendation letter, through the recommender terminal (40) and submits a recommendation letter (refer to (12) of FIG. 1), the reception is completed. This process is included when a third party (a recommender, mentor, teacher, etc.) other than the scholarship applicant participates by submitting relevant documents (e.g. a recommendation letter, mentoring plan, teacher's opinion letter, etc.) in the step of receiving the scholarship application papers. The mentor plan or the teacher's opinion letter, which is submitted by a mentor or a teacher, is also requested for by a similar process to the process of requesting for a recommendation letter.

The scholarship management server (20), when application papers, which are essential for applying for scholarship such as the scholarship application document, supporting documents, certification documents, and recommendation letter, are completely received from the applicant terminal (10), transmits applicant information to the scholarship operating institution server (30) (refer to (13) of FIG. 1), and provides the final selection result, which is received from the scholarship operating institution server (30), to the applicant terminal (10).

In addition, the scholarship management server (20) receives examiner information from the scholarship operating institution server (30), and requests for applicant evaluation to the examiner terminal (50) by e-mail, mobile message, etc. (refer to (14) of FIG. 1).

The scholarship management server (20), when the examination score of the examiner is completely entered (refer to (15) of FIG. 1), retransmits applicant information with the examination score to the scholarship operating institution server (30) (refer to (16) of FIG. 1). When a scholarship recipient is selected by the scholarship operating institution server (30), which has received the final applicant information, the scholarship management server (20) receives the list of the selected scholarship recipients from the scholarship operating institution server (30) (refer to (17) of FIG. 1). The scholarship management server (20) notifies the final selection result to the applicants through a communication channel called My Scholarship Display, which is connected to the applicants-only supporting unit (213) (refer to (18) of FIG. 1). In addition, the scholarship management server (20) receives a bank account number through the applicant terminal (10) of the applicant who is finally selected as the scholarship recipient (refer to (19) of FIG. 1), and transmits the bank account information to the scholarship operating institution server (30) (refer to (20) of FIG. 1). The scholarship operating institution server (30) transmits (refer to (22) of FIG. 1) the result of payment of scholarship money to the applicant terminal (10) through the scholarship management server (20) (refer to (21) of FIG. 1). This process is included when there are papers or money (e.g. a recommendation letter, evaluation document, donation) provided by a third party (a recommender, examiner, donor, etc.) other than the applicant for the scholarship to the scholarship operation institution in the step of handling scholarship business. Accordingly, the recommendation letter submitted by the recommender, evaluation document submitted by the examiner, evaluation participation expenses paid by the scholarship operation institution, details of income report, details of donation by the donor, details of donation report, etc. are transmitted through each party's My Scholarship Display, and are saved. In addition, though the details of handling business are different between the recommender, examiner, and donor, the handling process is similar to the process of operating the applicant's My Scholarship Display.

The website is simply designed to allow the least number of clicks on each menu item and undergo a rapid search, and serves for the applicant terminal (10), which has a normal computer operating system, etc. built-in and communication functions, as a software and homepage for supporting the applicant-oriented services, which are provided by the integrated scholarship management system, by installing the applicants-only supporting unit (213) as a menu or a separate website. To this end, the website is able to interface with the applicants through a gate page providing menus for services to aid in convenience for the applicant and an applicants-only supporting unit (213) having a service page corresponding to the choice of menu provided by the gate page.

In order to realize the operation, the scholarship management server (20) comprises: an applicant module (21); a service module (22); an external cooperation module (23); and a control module (24), as shown in FIG. 2.

The applicant module (21) is connected to the applicant terminal (10) to provide scholarship information to the applicant terminal (10), to receive information needed for supporting and managing scholarship such as scholarship application documents, supporting documents, etc., and to issue a registration number and notify the final selection result to the applicant terminal (10).

More specifically, the applicant module (21) comprises: a scholarship information providing unit (211); an information receiving unit (212); and the applicants-only supporting unit (213), as shown in FIG. 3a.

The scholarship information providing unit (211) provides scholarship information to the applicant terminal (10). That is, the scholarship information providing unit (211) provides scholarship information, which includes: a basic scholarship information group including the most basic data on scholarship saved in the scholarship DB such as the scholarship name, address of the scholarship operating institution server (30), type of scholarship, history of scholarship, scholarship money, number of scholarship recipients, scholarship money paid to each recipient, and period of payment of scholarship; a scholarship qualification category information group divided by test/certification such as language test score, qualification, and volunteer activities; scholarship money information group divided by payment detail provided by each scholarship; an additional service information group which saves scholarship service information additionally provided; a contact information group on the address, phone number, fax number, homepage, person in charge, etc. of the scholarship operation institution; a recruit date information group on the scholarship recipients recruit date, etc.; a program information group which saves detailed data on programs provided by the scholarship operation institution; and an information group which notifies if an applicant may apply for two or more scholarships, to be searched by the applicant terminal (10) accessing the website, as shown in FIG. 5.

The information receiving unit (212) receives the scholarship application documents, supporting documents, and various other documents and data from the applicant terminal (10). In addition, the information receiving unit (212) receives the bank account information, to which the scholarship money will be deposited, from the finally selected scholarship recipient, and the applicants-only supporting unit (213) transmits the evaluation results, notices, and year-end tax settlement result, which are notified by the scholarship operating institution server (30), to the applicant terminal (10) of the finally selected scholarship recipient.

The applicants-only supporting unit (213) is on each channel connected to the applicant terminal (10), which has submitted the scholarship application document, and thus directly provides the processing result and final selection result to the applicant terminal (10). The applicants-only supporting unit (213) provides the progress information of a variety of scholarship supporting procedures through My Scholarship Display, which will be described later herein. That is, the applicants-only supporting unit (213) comes to provide scholarship information to students through a short, bidirectional path by allowing the applicants to search and save information of the scholarship, for which the applicants have applied for, along with information of any other scholarship the applicants want to know about through My Scholarship Display as a user interface. That is, the applicants-only supporting unit (213) displays all results processed in the website provided by the scholarship management server (20), so that the applicants can check the progress and results of scholarship application and communicate with the operators of the scholarship by using My Scholarship Display, which serves as a bulletin for the application process, and, after they are selected as scholarship recipients, they can actively communicate with the scholarship operation institution through the Display. In addition, the applicants-only supporting unit (213) is able to search those scholarship recipient recruit notices which fit the search options, which are selected by the applicants, and deliver the information to the applicants by e-mail or text message.

The service module (22) is a device which provides a website for presenting scholarship information, comprehensively manages the scholarship recipient selection process after the scholarship application documents are received, and messages information generated in each process.

More specifically, the service module (22), as shown in FIG. 3b, comprises: a web service unit (221); an application document managing unit (222); a plagiarism verifying unit (223); a forged document determining unit (224); an application papers auto-generating unit (225); a certification information receiving unit (226); a recommendation letter receiving unit (227); an applicant evaluation information receiving unit (228); a conflicting-interests examining unit (229); an information managing unit (230); and an information transmitting unit (231).

The web service unit (221) is an interface which provides a website for presenting scholarship information. The web service unit (221) is connected to the database server 25) to control the operations of the website. The website is respectively accessed by a plurality of applicant terminals (10), recommender terminals (40), examiner terminals (50), and administrator of the scholarship operating institution server (30), and thus is able to conduct procedures such as submitting the scholarship application documents and various supporting documents, requesting for a recommendation letter, transmitting a message requesting for evaluation, etc.

The application document managing unit (222) classifies the scholarship application documents received by the information receiving unit (212) by at least one item among scholarship type, scholarship money, major, region, and religion. The classified scholarship application documents can be saved separately in the database server (25).

The plagiarism verifying unit (223) compares the scholarship application documents, which are classified by the application document managing unit (222), with other pre-saved scholarship application documents and verifies if there is any plagiarism. The plagiarism verifying unit (223) verifies if there is any plagiarism in creations, which requires creativity, such as the personal statement, study plan, portfolio, etc. among the scholarship application papers submitted by the applicants. To this end, the plagiarism verifying unit (223) has a notified plagiarism verifying program installed in advance.

The forged document determining unit (224) compares the scholarship application documents, which are classified by the application document managing unit (222), with the pre-saved other scholarship application documents and a pre-saved authentic document form, and then determines if the documents are forged. The forged document determining unit (224) determines if there is any forged document in those documents issued by a specific institution, such as a diploma certificate, qualification certificate, language test score certificate, certificate of award, etc. among the application documents submitted by the applicants. To this end, the forged document determining unit (224) has a forged document verifying program installed in advance.

The application papers auto-generating unit (225) extracts the scholarship application document which corresponds to the preset information on scholarship eligibility requirements among the scholarship application documents, which are classified by the application document managing unit (222), and automatically generates application papers required for applying for the scholarship by using the extracted scholarship application document.

The certification information receiving unit (226) receives qualification certification information for applying for the scholarship from the external certification agency server. In addition, the certification information receiving unit (226) may receive qualification certification information directly from the applicant terminal (10) separately from the external certification agency server.

The recommendation letter receiving unit (227) receives the recommendation letter for the scholarship from the recommender terminal (40). The recommendation letter receiving unit (227) receives the recommendation letter for the scholarship, which is provided by the recommender terminal (40) in response to the recommendation letter information requested by the recommender terminal (40) by the web service unit (221).

The applicant evaluation information receiving unit (228) receives examiner information from the scholarship operating institution server (30). The applicant evaluation information receiving unit (228) requests for applicant evaluation by providing, to the relevant examiner terminal (50), the application papers submitted by the applicants and receives applicant evaluation information including the examination score from the examiner terminal (50). Here, when the evaluation is successively conducted in several steps (first step of evaluation of documents, second step of interview, third step of presentation, etc.), the applicant evaluation information receiving unit (228) allocates the examiners for each step, and receives the applicant evaluation information including the examination score by step from the examiner terminal (50). In case of a multi-step evaluation, the applicant evaluation information receiving unit (228) repeats the processes of designating examiners, entering the examination score, notifying the selected scholarship recipients, etc.

The conflicting-interests examining unit (229) examines if there are any conflicting interests among the applicants, recommenders, examiners, operators of the scholarship operation institution, etc. in order to avoid conflicting interests and conduct fair evaluation. Specifically, the conflicting-interests examining unit (229) examines if a person is designated both as a recommender and an examiner for the same applicant, and allocates the examiners not to be the recommender at the same time for the same applicant. In addition, the conflicting-interests examining unit (229) examines if the applicant is a relative of the operators of the scholarship operation institution. To this end, the conflicting-interests examining unit (229) receives a written consent and a written oath for conducting the conflicting-interests examination.

The information managing unit (230) classifies the received papers, qualification certification information, recommendation letters, and applicant evaluation information by applicant, and manages them. The information managing unit (230) provides the information classified by applicant to the database server (25) to save the same.

The information transmitting unit (231) transmits the received papers, qualification certification information, recommendation letters, and applicant evaluation information to the scholarship operating institution server (30).

The external cooperation module (23) is connected to the financial institution server (70), the recommender terminal (40), and the examiner terminal (50) to transmit and receive information for procedures of supporting and managing scholarship. That is, the external cooperation module (23) is connected: to the financial institution server (70) to pay various fees; to the recommender terminal (40) to request for and receive a recommendation letter; and to the examiner terminal (50) to request for applicant evaluation and receive applicant evaluation information.

The control module (24) receives, handles, and manages the scholarship application documents, and controls operation of each component, which the scholarship management server (20) consists of, to message information of each relevant procedure. To this end, the control module (24) comprises an operation program for providing the integrated scholarship management service.

The recommender terminal (40) is a terminal device of a recommender who has the recommender qualification which is set by the scholarship operating institution server (30), which handles and operates payment of scholarship money. The recommender terminal (40) may receive the request for issuance of a recommendation letter for the applicant who has provided recommender information at the request of the scholarship management server (20), and may upload the requested recommendation letter onto the scholarship management server (20).

The examiner terminal (50) is a terminal device of an examiner who is designated by the scholarship operating institution server (30), which handles and operates payment of scholarship money to examine the qualification of the applicants. The examiner terminal (50) may receive the applicant information from the scholarship management server, evaluate the applicant on the basis of applicant information, generate the applicant evaluation information including the evaluation score, and transmit the applicant evaluation information to the scholarship management server (20).

The database server (25) is a device for saving information for paying and managing the scholarship, which is able to make a list of detailed information of scholarship such as scholarship application information, member information, a variety of supporting document files, information related to the scholarship operating institution server (30), etc. to process and organize the information for the applicants to search or select. The database server (25) serves as an information source linked with the scholarship management server (20) and/or scholarship operating institution server (30), etc.

More specifically, the database server (25) may comprise: a scholarship database (DB) (251) for saving scholarship information which is classified by at least one item among scholarship type, scholarship money, major, region, and religion; a member database (DB) (252) for saving applicant information and member information including login information; a file database (DB) (253) for saving the supporting document files or supporting documents submitted from the applicant terminal (10); and a management database (DB) (254) for saving information for selecting scholarship recipients in the scholarship operating institution server (30), paying the scholarship money to the selected scholarship recipients, and filing a tax report for the scholarship payment and executing a procedure for the year-end tax settlement.

Here, the scholarship DB (251) serves not only as the most important basic database used for searching the scholarship through the scholarship management server (20), but also as a means for reading information on each scholarship and searching a scholarship which meets the condition and qualification of an applicant. In addition, the scholarship DB (251) also works as basic data for recommending a scholarship. In addition, the scholarship DB (251) frequently updates by collecting information such as opinions of applicants on the application process and opinions on the scholarship evaluation through the applicants-only supporting unit (213), and the updated data are made into a database in the scholarship DB (251) for other students to use the information.

In addition, the scholarship DB (251) provides not only information on the scholarship desired but also a variety of search information including a list of recommended scholarships, a list of scholarships in each region, a list of scholarships for each major, a search list of scholarships for each qualification, etc. for applicants or other users to easily search the updated data of the database server (25) on the website.

In the present invention, the scholarship DB (251) is provided to the applicant terminal (10) through the website to perform functions for scholarship search portal and consultation on scholarship for making decisions on selecting scholarship. That is, the applicants can select the appropriate scholarship fulfilling their own conditions and qualifications with the scholarship DB (251) provided to themselves, and the time and cost required for searching and applying for scholarship can be reduced because when a student enters and saves information such as his or her nationality, region, major, and qualifications in the search entry field, the scholarship, which is appropriate for him or her or is available based on his or her qualifications, is automatically searched.

The financial institution server (70) is a server device of a financial institution for the applicants to pay the application fee for the scholarship. It receives a request for paying the fee for the scholarship application documents from the applicant terminal (10), executes the payment, and deposits the scholarship money to the finally selected scholarship recipient. In addition, the financial institution server (70) deposits the evaluation participation expenses to the examiner who has participated in the evaluation.

The scholarship operating institution server (30) is a server device of an operation body or a management body for selecting the scholarship recipients and paying the scholarship money to the selected scholarship recipients, which receives applicant information from the scholarship management server (20), selects the scholarship recipients on the basis of the received applicant information, transmits the information of the applicant who is selected as a scholarship recipient to the scholarship management server (20), deposits the scholarship money into the bank account provided by the selected scholarship recipients (personal or school account), files a tax report for the payment of the scholarship, and notifies the year-end tax settlement result of the scholarship payment to the scholarship management server (20). Specifically, in the step of selecting a scholarship recipient, the scholarship operating institution server (30) provides the list of examiners to the scholarship management server (20), receives the applicant evaluation information assessed by the examiners from the scholarship management server (20), and finally selects the scholarship recipients on the basis of the information.

When the bank account provided by the finally selected scholarship recipient is a bank account of the educational institution to which the finally selected scholarship recipient belongs, the scholarship operating institution server (30) receives a deposit confirmation certificate from the pertinent financial institution after depositing the scholarship money, and notifies that the deposit is confirmed to the educational institution server (80) of the educational institution to which the finally selected scholarship recipient belongs.

When the scholarship operating institution server (30) transmits the deposit result to the scholarship management server (20), the details of the deposit of scholarship money is transmitted to the display of the relevant applicant terminal (10).

In addition, after transmitting the year-end tax settlement result for each student to the scholarship management server (20) at the end of the year, the scholarship operating institution server (30) notifies the details of issuance of the year-end tax settlement report by mobile text message etc. through the applicant terminal (10). The scholarship operating institution server (30) directly and collectively files a scholarship income report, evaluation participation expenses income report, and donation report to the government agency server (90) of government agencies such as the National Tax Service. Here, the income report and the donation report may be designed to be directly filed from the scholarship management server (20) to the government agency server (90) entrusting the scholarship operation institution.

The scholarship operating institution server (30) may comprise public/private institutions such as scholarship foundations, religious groups, NGOs, enterprises, and schools which operate an on-campus scholarship program, etc.

The educational institution server (80) is a server device which receives the information of the notice for recruiting scholarship recipients, which is transmitted by the scholarship operating institution server (30) to the scholarship management server (20), and the result of payment of the scholarship money to the finally selected scholarship recipients. An educational institution is defined as a school at which the scholarship recipient attends or will enroll. Such a school serves both as a scholarship operation institution, which operates an on-campus scholarship, and as an educational institution such as a university or graduate school.

The government agency server (90) is a server device to which the scholarship operating institution server (30) files a tax report on the payment of scholarship and which transmits the year-end tax settlement result on the scholarship payment to the scholarship operating institution server (30). It may be a server device of a tax-related agency such as the National Tax Service and a local tax office.

In the integrated scholarship management system according to an embodiment of the present invention, since a variety of complex processes such as searching scholarship information, applying for scholarship, performing evaluation, selecting scholarship recipients, paying scholarship money, and filing a tax report are collectively handled by steps within a single platform, the applicant's convenience can be improved. In addition, when an applicant searches for scholarships, search effectiveness can be enhanced by converting the notice for recruiting scholarship recipients provided by the scholarship operation institution into digital data.

In addition, by developing technology to collectively handle online and digitally scholarship-related businesses, which were processed by various participants online/offline through a mixture of analog data and digital data, an embodiment of the present invention can build scholarship-related data, use the scholarship-related data for analyzing the future scholarship market, and detect plagiarists using verification technology which can determine if a document is forged or contains any plagiarism, thereby improving fairness of evaluations.

In addition, an embodiment of the present invention can avoid conflicting interests among applicants, the recommender/mentor/teacher, examiner, and operators of the scholarship operation institution by examining in advance if the recommender and the examiner are the same person, if an operator of the scholarship operation institution is a relative of the applicant, etc.

In addition, an embodiment of the present invention can prevent waste of time and money due to double application for scholarship by collecting and analyzing information of scholarship operated by all scholarship operation institutions such as public scholarship institutions, private scholarship institutions, educational institutions, etc. and then in advance controlling double application for a scholarship in the step of applying for scholarship.

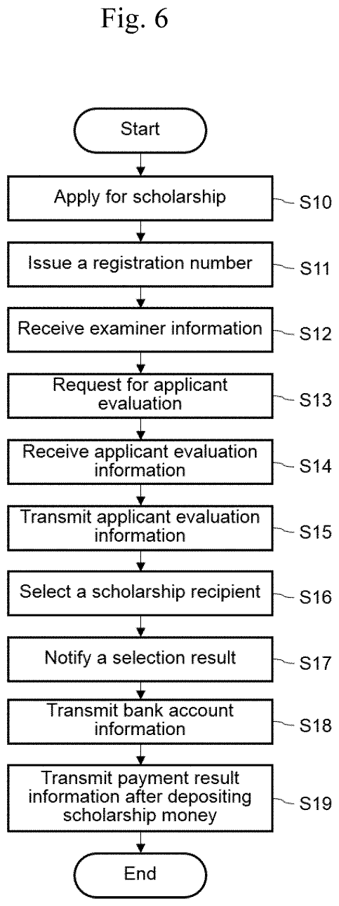

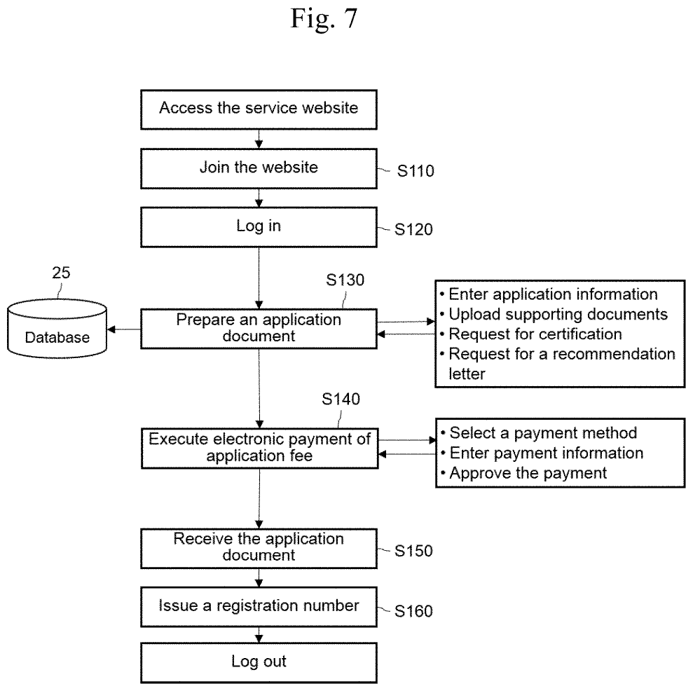

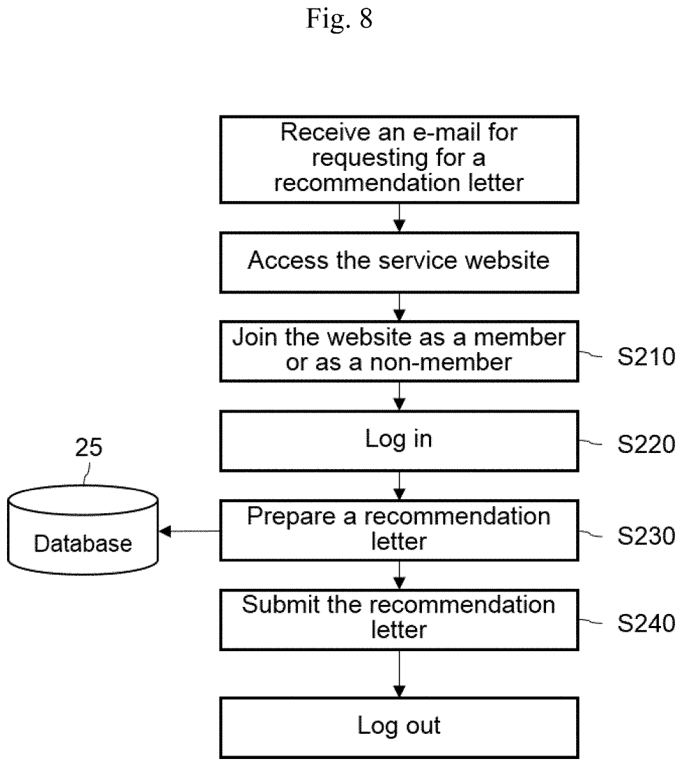

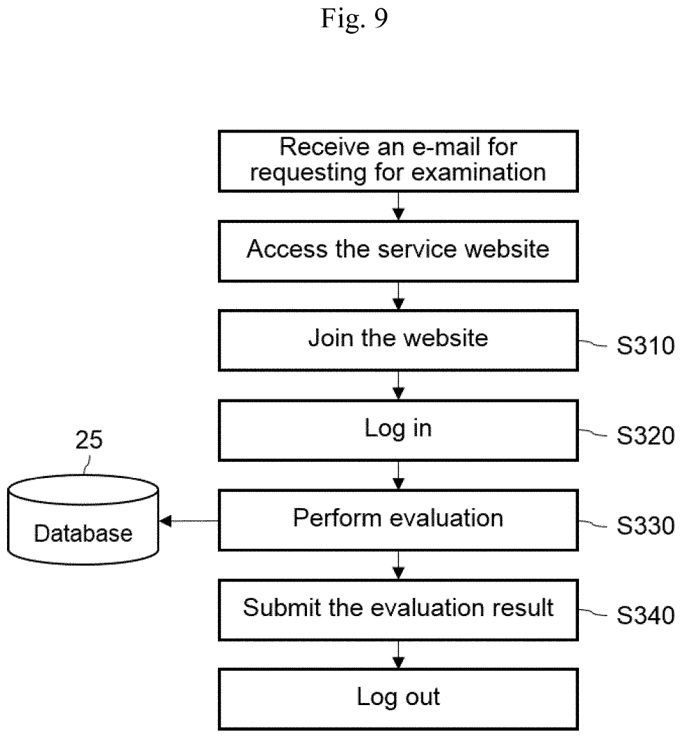

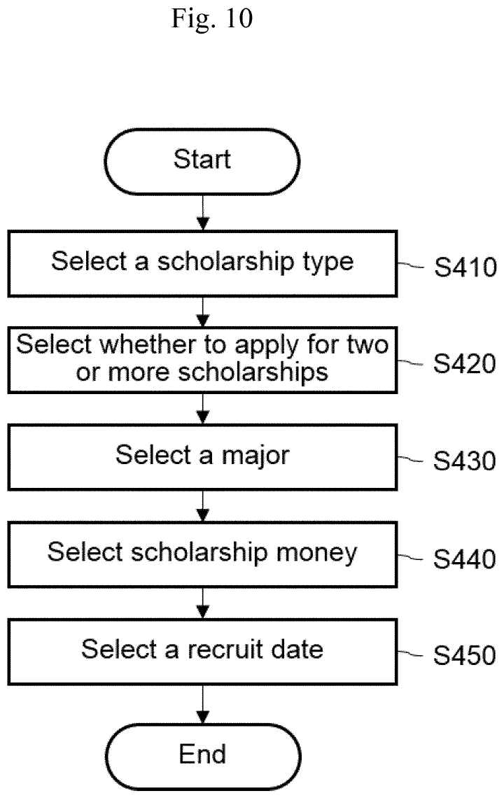

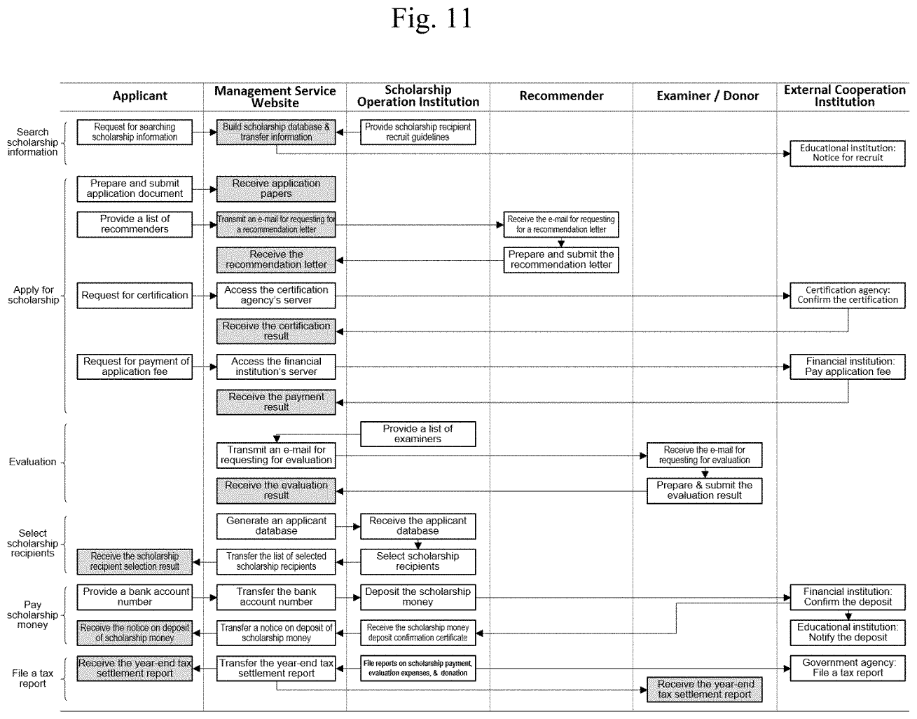

FIG. 6 is a flowchart which shows the method for operating the scholarship according to another embodiment of the present invention. FIG. 7 is a flowchart which shows the flow, with special emphasis on the applicant, in the method for operating the scholarship according to another embodiment of the present invention. FIG. 8 is a flowchart which shows the flow, with special emphasis on the recommender, in the method for operating the scholarship according to another embodiment of the present invention. FIG. 9 is a flowchart which shows the flow, with special emphasis on the examiner, in the method for operating the scholarship according to another embodiment of the present invention. FIG. 10 is a flowchart which shows the process of searching scholarship in the method for operating the scholarship according to another embodiment of the present invention. FIG. 11 is a drawing which shows the method for comprehensively managing the general processes of scholarship business such as searching scholarship information, applying for scholarship, selecting the scholarship recipients, paying the scholarship money, filing a scholarship income report, etc. by using the method for operating the scholarship according to another embodiment of the present invention.

Referring to FIG. 6, the method for operating the scholarship according to another embodiment of the present invention comprises: a first step (S10) of accessing the website provided by the scholarship management server (20) through an execution of the application for applying for scholarship installed in the applicant terminal (10), searching the scholarship information, preparing a scholarship application document including applicant information, and providing the qualification certification information certified by the external certification agency server, a second step (S11) of receiving the scholarship application document from the applicant terminal (10) and issuing a registration number; a third step (S12) of transmitting the applicant information to the scholarship operating institution server (30) and receiving examiner information from the scholarship operating institution server (30); a fourth step (S13) of requesting for applicant evaluation to the examiner terminal on the basis of the examiner information; a fifth step (S14) of receiving the applicant evaluation information reflecting the evaluation from the examiner terminal; a sixth step (S15) of transmitting the applicant evaluation information and the applicant information, on which the evaluation is performed, to the scholarship operating institution server (30); a seventh step (S16) of selecting a scholarship recipient on the basis of the applicant evaluation information and the applicant information and transmitting the information of the selected scholarship recipient to the scholarship management server (20); an eighth step (S17) of transmitting a final selection result to the applicant terminal (10) of a finally selected scholarship recipient on the basis of the scholarship recipient information; a ninth step (S18) of receiving bank account information from the applicant terminal (10) of the finally selected scholarship recipient and transmitting the bank account information to the scholarship operating institution server (30); and a tenth step (S19) of depositing the scholarship money into the bank account, which is transmitted in the ninth step (S18), and transmitting the payment result information to the scholarship management server (20).

The first step (S10) is a step of the applicant accessing the website, searching scholarship information, preparing the scholarship application document, and providing qualification certification information, which is certified by an external certification agency server. The first step (S10) saves the search result at the website in the database server (25), uploads the scholarship application document and supporting documents including qualification certification information onto the website, and requests for reception. Here, the applicant terminal (10) requests for an electronic certification to the gateway server of the certification agency's certification system (i.e. the external certification agency server) for acquiring qualification certification information, and the gateway server of the certification system provides the electronic certification form to the website to transfer the electronic certification form to the applicant. Next, the applicant terminal (10) accesses the website, and the applicant enters information required for certification and requests for approval to the gateway server of the certification system. Then, the gateway server transmits the certification result to the website, and the website saves the certification result value in the database server (25).

The second step (S11) is a step of receiving the scholarship application document from the applicant terminal (10) and issuing a registration number. The second step (S11) issues a registration number for the scholarship application document submitted by the applicant, who has accessed the website, and saves the scholarship application document and supporting documents in the database server (25).

The second step (S11) determines whether the scholarship application document corresponds to the preset information on scholarship eligibility requirements, and if the scholarship application document is determined to correspond to the preset information on scholarship eligibility requirements, a registration number for the scholarship application document may be automatically issued.

The information on scholarship eligibility requirements may include the detailed qualifications as in Table 2.

TABLE 2

| Category | Standards for Selection (Detailed Qualifications) |
|---|---|
| Personal | 1. Nationality 2. Age 3. Academic Background 4. School |
| Information | |
| Good Grades | 1. Credits (grades, subjects of completion/number of |
| | subjects, rank, etc.) 2. Language test score/scores of various |
| | examinations (Korean language, Korean history, TOEFL, |
| | GRE, etc.) |
| Income | 1. National basic livelihood security recipient 2. Lower |
| Level | income group 3. Resident of public housing 4. Property tax |
| | range of parents |
| Specific | 1. Resident in a specific region (Seoul Metropolitan City, |
| Condition | Daejeon City, Seongnam City, etc.) 2. Student who is going |
| 1: Region | to enter a school in a specific region/an enrolled student in |
| | such a school (Seoul, foreign country, etc.) 3. Person who |
| | is recommended by the regional recommendation system |
| Specific | 1. Family of a person with a specific occupation (child of a |
| Condition | soldier, firefighter, etc.) 2. A person from a specific group |
| 2: Group | (a recipient of a specific scholarship, a graduate from a |
| | specific school, etc.) 3. A student who enters a specific |
| | school/an enrolled student in such a school (a science high |
| | school, foreign language high school, etc.) 4. A student |
| | with a specific major (an enrolled student in a medical |
| | school, college of engineering, etc.) |
| Specific | 1. A person who has received an award (for mathematics, |
| Condition 3: | science, arts, music, physical education, skills, creativity, |
| Capabilities | etc.) 2. A person with a specialty (a bearer of a |
| | specialty/skill, etc.) 3. A person with excellent leadership (a |
| | person with excellent community activities) 4. A person |
| | with excellent volunteer activities |
| Presence or | 1. Presence or absence of exemption/reduction of |
| Absence | examination fee 2. Presence or absence of scholarship |
| of Double | benefits from other institutions |
| Benefits | |
| Presence of | 1. Presence or absence of deprivation of scholarship |
| Absence of | qualification in the past 2. Presence or absence of |
| Punishment | disciplinary measures taken by school authorities |
| Conflicting | 1. Whether a relative of the applicant works for the |
| Interests | scholarship operation institution or not |

Meanwhile, in the first step (S10), the scholarship application document comprises recommender request information.

Accordingly, between the first step (S10) and the second step (S11) may further be included: a first process of requesting for issuance of a recommendation letter for scholarship for the applicant to the recommender terminal (40) in accordance with the recommender request information; and a second process of receiving the recommendation letter for scholarship, which is requested in the first process, from the recommender terminal. Here, the first process may be completed by the applicant accessing the scholarship management server (20) and requesting an e-mail or mobile text message to request for a recommendation letter to the recommender. Next, in the second process, the recommender, who has received the e-mail of a request for a recommendation letter, which is transmitted from the scholarship management server (20), may access the website, which is linked with the e-mail, and prepare and submit a recommendation letter, and the website may transfer the information on whether the recommendation letter is submitted or not to the scholarship management server (20) and save the information in the database server (25) at the same time.

In addition, in the second step (S11), when the applicant terminal (10) accesses the scholarship management server (20) and requests for an electronic payment to the gateway server of the financial institution server (70), the gateway server of the financial institution server (70) may provide an electronic payment form to the website of the scholarship management server (20). Next, in the second step (S11), the electronic payment form is transferred to the applicant terminal (10) through the website. When the applicant terminal (10) submits the scholarship application papers on the website, enters electronic payment information, and requests for approval to the gateway server, the gateway server may transmit the payment result (approval/disapproval) to the website, and the website may transfer the payment processing result to the scholarship management server (20) and save the payment result value in the database server (25).

The third step (S12) transmits the applicant information to the scholarship operating institution server (30), and receives the examiner information from the scholarship operating institution server (30). In addition, the third step (S12) may examine if the recommender and the examiner are the same person, transfer the result of the examination to the scholarship management server (20), and save the payment result value in the database server (25).

The fourth step (S13) requests for applicant evaluation to the examiner terminal on the basis of the examiner information. Here, in the fourth step (S13), the scholarship operating institution server (30) accesses the website of the scholarship management server (20), and request for transmission of an e-mail and a mobile text message to request for examination to the examiner.

The fifth step (S14) receives the applicant evaluation information, which reflects the evaluation, from the examiner terminal (50). In the fifth step (S14), when the examiner, who has received the e-mail requesting for evaluation transmitted by the scholarship management server (20), accesses the website linked with the e-mail, performs evaluation by downloading or accessing online the matters to be evaluated (e.g. the personal statement, study plan, recommendation letter, mentor plan, etc.), and submits the examination result, the website saves the examination result value in the database server (25).

The evaluation may be repeatedly conducted by combining some or several steps as in Table 3 below.

TABLE 3

| Category | Subject of Evaluation | Details of Evaluation |
|---|---|---|
| First Step | Screening of basic | Evaluate whether a standard value of |
| | conditions targeting | specific conditions (grades, major, |
| | all applicants | scores, etc.) is satisfied or conduct a |
| | | quantitative evaluation. |
| Second | In-depth document | Perform a qualitative evaluation on |
| Step | examination targeting | the submitted data such as the |
| | those who have passed | personal statement, recommendation |
| | the first step or all | letter, etc. |
| | applicants | |
| Third | Successive execution | Conduct processes of |
| Stepor | of interview, | complementing the results of the |
| higher | presentation, etc. | quantitative evaluation and the |
| | targeting those who | qualitative evaluation through in- |
| | have passed the second | person examinations such as |
| | step in accordance | interview and presentation, and |
| | with the examination | directly checking the details of the |
| | principles | application papers. |

The sixth step (S15) transmits the applicant evaluation information and the applicant information, on which the evaluation is conducted, to the scholarship operating institution server (30). In addition, the sixth step (S15) generates the applicant information saved in the database server (25) connected to the scholarship management server (20) into an applicant DB. Here, the scholarship operating institution server (30) may access the scholarship management server (20), convert the applicant DB saved in the database server (25) into computer-readable files such as Excel files, and download the files.

The seventh step (S16) selects the scholarship recipients on the basis of the applicant evaluation information and the applicant information, and transmits the information of the selected scholarship recipients to the scholarship management server (20). The eighth step (S17) transmits a final selection result to the applicant terminal (10) of the finally selected scholarship recipient on the basis of the scholarship recipient information. That is, when in the seventh step (S16), the scholarship operating institution server (30) submits the list of the scholarship recipients to the scholarship management server (20), the eighth step (S17) displays a message of whether an applicant is selected as a scholarship recipient or not on the applicants-only supporting unit (213) connected to the scholarship management server (20). Here, the applicants who are not selected as a scholarship recipient, may request for all submitted data to be deleted from the database server. In addition, the eighth step (S17) may provide the applicant with feedback information including information on the reason why the applicants were not selected as a scholarship recipient.

The ninth step (S18) receives bank account information from the applicant terminal (10) of the finally selected scholarship recipient, and transmits the information to the scholarship operating institution server (30). That is, in the ninth step (S18), when the finally selected scholarship recipient provides the number of a bank account, to which the scholarship money is going to be deposited (e.g. a personal bank account of the recipient, a bank account of the university, etc.), to the applicants-only supporting unit (213) connected to the scholarship management server (20), the scholarship operating institution server (30) collectively receives the bank account number of the scholarship recipient from the scholarship management server (20), and deposits the scholarship money into the bank account.

The tenth step (S19) deposits the scholarship money to the bank account, which is transmitted in the ninth step (S18), and transmits the information of the result of the deposit to the scholarship management server (20). That is, after the scholarship operating institution server (30) deposits the scholarship money to the financial institution, the tenth step (S19) may collectively transfer the result of the deposit to the applicants-only supporting unit (213) connected to the scholarship management server (20), and display a message of completion of scholarship payment to each of the applicants or notify the completion of scholarship payment through a mobile text message.

Next, the scholarship operating institution server (30) files a report on the details of scholarship payment to the National Tax Service, generates a year-end income tax settlement report to the scholarship recipient, transfers the year-end income tax settlement report to the applicants-only supporting unit (213) connected to the scholarship management server (20), and displays the message of completion of registration of the year-end tax settlement report. Meanwhile, scholarship money, school expenses, etc. are considered non-taxable income according to Article 12 of the Income Tax Act.

Hereinafter, is the disclosure of a more specific description of the business handling process of the applicants who apply for scholarship, recommenders who prepare a recommendation letter, and examiners who evaluate the applicants in the method for operating the scholarship according to another embodiment of the present invention.

Referring to FIG. 7, in the method for operating the scholarship according to another embodiment of the present invention, with special emphasis on the applicant, first, the applicant joins the website as a member (S110) for submitting the scholarship application papers to the website, receives an issued ID and a password, executes the login procedure (S120), and then prepares a scholarship application document required for the scholarship (S130). Specifically, the applicant enters the application information regarding themselves, uploads supporting documents in accordance with the list of supporting documents required by the scholarship, requests for certification of matters which require certification, such as language test scores, qualification certificates, volunteer activities, etc. receives the certification, submits the name, e-mail address, mobile phone number, etc. of the recommender, to which the applicant will request for a recommendation letter, request for the website to transmit an e-mail and a text message requesting for a recommendation letter, and checks if the scholarship application papers are submitted. The submitted scholarship application papers are saved in the database server (25). Here, the details saved in the database server (25) is determined to be effective when the processes of preparing an application document, uploading supporting documents, verifying the certification, submitting the recommendation letter, and paying the application fee are all completed before the final deadline of submission of the scholarship application document (in view of the login status before the deadline). The scholarship application document and the supporting documents are saved in the file DB of the database server (25). Meanwhile, when there is no separate application fee, the electronic payment of application fee is omitted. For a scholarship with an application fee (e.g. a scholarship for a student studying abroad at government expense), the applicant must select a payment method under the electronic payment menu, enter the payment information, and receive the payment approval (S140). In addition, if no recommendation letter is required to apply for scholarship, the website receives the scholarship application papers (S150) on the website after the payment is approved, and issues a registration number (S160). If a recommendation letter is required to be submitted, when the payment is approved, a message indicating that the application papers are being received is transferred to the applicants-only supporting unit (213) and is provided through My Scholarship Display, which is the applicants-only display. In addition, when the recommender submits a recommendation letter, a message indicating that the application papers have all been received is transferred through the same path.

Referring to FIG. 8, in the method for operating the scholarship according to another embodiment of the present invention, with special emphasis on the recommender, an e-mail and a text message requesting for a recommendation letter are transmitted to the e-mail of the recommender submitted by the applicant, and the recommender, who has received the e-mail, joins the website as a member (S210), receives an issued ID and a password, and logs in (S220) to the website. The recommender then, prepares (S230) a recommendation letter on the website linked with the e-mail or uploads a recommendation letter for submission (S240). The recommender may submit a recommendation letter as a member or not as a non-member.

Referring to FIG. 9, in the method for operating the scholarship according to another embodiment of the present invention, with special emphasis on the examiner, the examiners are designated offline in advance by the scholarship operating institution server (30), and the list of the designated examiners is provided to the scholarship management server (20). Then, the scholarship management server (20) allocates the registration number of the applicant who will be evaluated by an examiner in accordance with a certain standard (standards for selecting the scholarship recipients are applied including random selection, result of examination of conflicting interests, expertise of the examiner, etc.). When the website connected to the scholarship management server (20) transmits an e-mail requesting for examination to an examiner, the examiner must join the website as a member (S310), receive an issued ID and a password, and log into the website (S320). The examiner then, downloads the data of the applicant to be evaluated in the website linked with the website connected to the e-mail requesting for the evaluation or evaluates the applicant online (S330), and submits the evaluation and the score (S340) by manually entering in the information.

Referring to FIG. 10, in the method for operating the scholarship according to another embodiment of the present invention, the process of searching scholarship information may select and present the most appropriate scholarship for the applicant when the applicant searches by manually entering the keyword in the search entry field or by searching using an item classified and displayed in advance (e.g. scholarship type, scholarship money, major, region, religion, etc.), allow the applicant to determine and select a scholarship in accordance with his or her own conditions and qualifications by the least number of clicks and through a rapid search, and allow the applicant to save the searched scholarship information in a separate entry field.

Referring to FIG. 11, the method for the scholarship business management using the scholarship operating system according to another embodiment of the present invention can efficiently execute scholarship business management through multi-processing conducted in a system wherein the scholarship management server (20), which provides the website, is connected to the gateway of the scholarship operating institution server (30), the external certification agency server (60) (qualification certificates, language test score certificates, volunteer activity certificates, etc.), the financial institution server (70) (a payment system, deposit system), the educational institution server (80), and the government agency server (90) (National Tax Service, minwon.go.kr, etc.), the applicant terminal (10), the recommender terminal (40), the examiner terminal (50), etc., through the Internet.

To this end, first of all, the applicant terminal (10) (e.g. a computer of the applicant) logs into the website of the scholarship management server (20) through the Internet, and searches information on the scholarship the applicant desires or is qualified for. Next, the applicant terminal (10) submits scholarship application papers in accordance with the search result of the scholarship information, and the scholarship management server (20) enters the examination result, generates the applicant DB, and transmits the applicant DB to the scholarship operating institution server (30) online. Then, the scholarship operating institution server (30) finally selects the scholarship recipients, and transmits the final selection result to the scholarship management server (20). The scholarship management server (20) then notifies the final selection result through the applicants-only supporting unit (213) directly connected to the applicant terminal (10). Next, the scholarship operating institution server (30) notifies that the scholarship money is deposited to the finally selected scholarship recipients through the scholarship management server (20), and provides the data for the year-end tax settlement. Through this process, the method for operating the scholarship can realize the complex processes of searching scholarship information through various paths, submitting scholarship application papers, entering the examination score, depositing the scholarship money, filing a tax report on the scholarship, evaluation expenses, donations, etc., within a single online platform.

The above description is only an embodiment for implementing the integrated scholarship management system and the method for operating the scholarship using the same according to the present invention. While the foregoing is directed to embodiments of the disclosure, other and further embodiments of the disclosure may be devised without departing from the basic scope thereof, and the scope thereof is determined by the claims that follow.

1. An integrated scholarship management system, comprising:
an applicant terminal, in which an application for applying for scholarship is installed, for searching scholarship information by accessing a website through an execution of the application for applying for scholarship, preparing a scholarship application document including information on an applicant, and providing qualification certification information certified by an external certification agency server;
a scholarship management server for providing at least one piece of scholarship information through the website, receiving the scholarship application document from the applicant terminal and issuing a registration number, and presenting a final selection result for the scholarship to the applicant terminal; and
a scholarship operating institution server for receiving the applicant information from the scholarship management server, selecting scholarship recipients on the basis of the received applicant information, transmitting the applicant information of an applicant selected as a scholarship recipient to the scholarship management server, paying the scholarship money to a bank account of the applicant selected as a scholarship recipient, filing a tax report for the scholarship payment, and notifying a year-end tax settlement result of the scholarship payment to the scholarship management server.

2. The integrated scholarship management system as in claim 1, wherein:
the scholarship application document further comprises bank account information or recommender information; and
the scholarship management server provides a scholarship application form fill-out program preset on the website.

3. The integrated scholarship management system as in claim 1, further comprising:
a recommender terminal for receiving a request for issuing a recommendation letter for the applicant who provides recommender information at the request of the scholarship management server,
wherein the recommender terminal uploads the requested recommendation letter for scholarship onto the scholarship management server.

4. The integrated scholarship management system as in claim 1, further comprising:
an examiner terminal for receiving the applicant information from the scholarship management server and evaluating the applicant,
wherein the examiner terminal transmits the applicant evaluation information including the evaluation score to the scholarship management server.

5. The integrated scholarship management system as in claim 1, wherein:
the scholarship management server receives examiner information from the scholarship operating institution server; and
the scholarship operating institution sever receives the applicant evaluation information from the scholarship management server.

6. The integrated scholarship management system as in claim 1, further comprising:
a financial institution server for receiving a payment request for a scholarship application fee from the applicant terminal, executing the payment, and paying the scholarship money to the finally selected scholarship recipient;
an educational institution server for receiving information on a notice for the scholarship recipient from the scholarship operating institution server, and receiving the payment result of the scholarship for the finally selected scholarship recipient; and
a government agency server for receiving the tax report filed for the payment of the scholarship from the scholarship operating institution server, and transmitting the year-end tax settlement result of the scholarship payment to the scholarship operating institution server.

7. The integrated scholarship management system as in claim 1, further comprising:
a database server for saving information for paying and managing the scholarship,
wherein the database server comprises:
a scholarship database (DB) for saving scholarship information which is classified by at least one item among scholarship type, scholarship money, major, region, and religion;
a member database (DB) for saving applicant information and member information including login information;
a file database (DB) for saving the supporting document files or supporting documents submitted from the applicant terminal; and
a management database (DB) for saving information for selecting scholarship recipients in the scholarship operating institution server, paying the scholarship money to the selected scholarship recipients, and saving information for filing a tax report for the scholarship payment and executing a year-end tax settlement.

8. The integrated scholarship management system as in claim 1, wherein the scholarship management server comprises:
an applicant module connected to the applicant terminal for providing scholarship information, receiving the scholarship application document, issuing the registration number, and presenting a final selection result;
a service module for providing a website containing scholarship information, processing and managing the scholarship application documents after receiving them, and messaging each piece of the procedure information;
an external cooperation module connected to the financial institution server, the recommender terminal, and the examiner terminal for transmitting and receiving the information on the procedures for supporting and managing the scholarship; and
a control module for controlling the operation of each component that the scholarship management server consists of.

9. The integrated scholarship management system as in claim 8, wherein the applicant module comprises:
a scholarship information providing unit for providing the scholarship information to the applicant terminal;
an information receiving unit for receiving the scholarship application document, member information, supporting document files, or supporting documents from the applicant terminal; and
an applicants-only supporting unit connected on each channel to the applicant terminal, from which the scholarship application document is submitted, for presenting the processing result and the final selection result,
wherein:
the information receiving unit receives the bank account information designated for the deposit of the scholarship money from the finally selected scholarship recipient; and
the applicants-only supporting unit transmits the year-end tax settlement result notified from the scholarship operating institution server to the applicant terminal of the finally selected scholarship recipient.

10. The integrated scholarship management system as in claim 8, wherein the service module comprises:
a web service unit for providing the website containing scholarship information;
an application document managing unit for classifying the received scholarship application documents by at least one item among scholarship type, scholarship money, major, region, and religion;
a plagiarism verifying unit for comparing the classified scholarship application documents with other pre-saved scholarship application documents and verifying the presence or absence of plagiarism;
a forged document determining unit for comparing the classified scholarship application documents with a pre-saved authentic document form and determining if the documents are forged;
an application papers auto-generating unit for extracting the scholarship application document which corresponds to the preset information on scholarship eligibility requirements among the classified scholarship application documents, and automatically generating application papers required for applying for the scholarship by using the extracted scholarship application document;
a certification information receiving unit for receiving qualification certification information for applying for the scholarship from the external certification agency server;
a recommendation letter receiving unit for receiving the recommendation letter for scholarship from the recommender terminal;
an applicant evaluation information receiving unit for providing the applicant information to the examiner terminal on the basis of the examiner information received from the scholarship operating institution server, requesting for evaluation of the applicant, and receiving the applicant evaluation information including the examination score from the examiner terminal;
a conflicting-interests examining unit for examining if there are conflicting interests between applicants and recommenders or between applicants and scholarship operation institutions on the basis of the applicant information and the recommender information, which are received from the scholarship management server, and the examiner information and the operator information of the scholarship operation institution, which are received from the scholarship operating institution server;
an information managing unit for classifying the application papers, qualification certification information, recommendation letter for scholarship, and applicant evaluation information for each applicant, and managing them; and
an information transmitting unit for transmitting the application papers, qualification certification information, recommendation letter for scholarship, and applicant evaluation information to the scholarship operating institution server.

11. The integrated scholarship management system as in claim 6, wherein:
the scholarship operating institution server transfers the examiner information to the scholarship management server, participates in the evaluation on the basis of the transferred examiner information, transmits the results of evaluation to the scholarship management server, pays the evaluation participation expenses to a designated bank account of the examiner, files a tax report for the payment of the evaluation participation expenses, and notifies a year-end tax settlement result of the payment of the evaluation participation expenses to the scholarship management server; and
the government agency server receives the tax report filed for the payment of the evaluation participation expenses from the scholarship operating institution server, and transmits the year-end tax settlement result of the payment of the evaluation participation expenses to the scholarship operating institution server.

12. The integrated scholarship management system as in claim 6, wherein:
the scholarship operating institution server transfers the information of a donor who has given a donation to the scholarship operation institution to the scholarship management server, reports about the donation, and notifies a year-end tax settlement result of the donation given to the scholarship operation institution to the scholarship management server; and
the government agency server receives the report on the donor who has given the donation to the scholarship operation institution from the scholarship operating institution server, and transmits the year-end tax settlement result of the donation to the scholarship operating institution server.

13. A method for operating the scholarship, which manages the scholarship operation process by using the integrated scholarship management system according to claim 1, the method comprising:
a first step of accessing the website provided by the scholarship management server through an execution of the application for applying for scholarship installed in the applicant terminal, searching the scholarship information, preparing a scholarship application document including applicant information, and providing qualification certification information certified by the external certification agency server;
a second step of receiving the scholarship application document from the applicant terminal and issuing a registration number;
a third step of transmitting the applicant information to the scholarship operating institution server and receiving examiner information from the scholarship operating institution server;
a fourth step of requesting for applicant evaluation to the examiner terminal on the basis of the examiner information;
a fifth step of receiving the applicant evaluation information reflecting the evaluation from the examiner terminal;
a sixth step of transmitting the applicant evaluation information and the applicant information, on which the evaluation is performed, to the scholarship operating institution server;
a seventh step of selecting a scholarship recipient on the basis of the applicant evaluation information and the applicant information and transmitting the information of the selected scholarship recipient to the scholarship management server;
an eighth step of transmitting a final selection result to the applicant terminal of a finally selected scholarship recipient on the basis of the scholarship recipient information;
a ninth step of receiving the inputted bank account information from the applicant terminal of the finally selected scholarship recipient and transmitting the bank account information to the scholarship operating institution server; and
a tenth step of depositing the scholarship money into the bank account and transmitting the payment result information to the scholarship management server.

14. The method for operating the scholarship as in claim 13, wherein:
the scholarship application document in the first step comprises recommender request information; and
the part between the first step and the second step further comprises:
a process of requesting for issuance of a recommendation letter for scholarship for the applicant to the recommender terminal in accordance with the recommender request information; and
a process of receiving the requested recommendation letter for scholarship from the recommender terminal.

15. The method for operating the scholarship as in claim 13, wherein:
the second step determines whether the scholarship application document corresponds to the preset information on scholarship eligibility requirements or not, and if the scholarship application document is determined to correspond to the preset information on scholarship eligibility requirements, a registration number for the scholarship application document is automatically issued.

16. The method for operating the scholarship as in claim 13, further comprising:
a step of the scholarship operating institution server performing at least one of the procedures of filing the tax report for the scholarship payment to the selected scholarship recipient, filing the tax report for the participation expenses payment to the examiner who has participated in the scholarship recipient selection process, and reporting about the donor who has given a donation to the scholarship operation institution, receiving a year-end tax settlement report document, and transmitting the year-end tax settlement report document to the scholarship management server.
